(19) United States
(12) Patent Application Publication
(10) Pub. No.: US 2010/0271170 A1
(43) Pub. Date: Oct. 28, 2010

(54) TRIPPING ELEMENT FOR AN ON-BOARD MOTOR-VEHICLE ELECTRICAL SYSTEM

(75) Inventors: Peter Meckler, Hohenstadt/Pommelsbrunn (DE); Michael Naumann, Feucht (DE); Frank Gerdinand, Helmstedt (DE)

Correspondence Address: LERNER GREENBERG STEMER LLP, P O BOX 2480, HOLLYWOOD, FL, 33022-2480, US

(73) Assignee: ELLENBERGER & POENSGEN GMBH, Altdorf (DE)

(21) Appl. No.: 12/760,587

(22) Filed: Apr. 15, 2010

(30) Foreign Application Priority Data
Apr. 23, 2009 (DE) 10 2009 018 612.3

(51) Int. Cl. H01H 37/02

(52) U.S. Cl. 337/298

(57) ABSTRACT

A tripping element for a current path in an on-board electrical system of a motor vehicle, has a voltage input, a load output for connecting a load, and also a thermal circuit breaker which is connected within the current path between the voltage input and the load output and provides DC isolation for the current path as a result of an actuation signal.

### CROSS-REFERENCE TO RELATED APPLICATION

This application claims the priority, under 35 U.S.C. §119, of German application DE 10 2009 018 612.3, filed Apr. 23, 2009; the prior application is herewith incorporated by reference in its entirety.

### BACKGROUND OF THE INVENTION

### Field of the Invention

The invention relates to a tripping element for a current path of an on-board electrical system of a motor vehicle.

Safety regulations in modern motor vehicles often require that an on-board electrical system or a specific current path within the on-board electrical system of a motor vehicle be permanently isolated from a vehicle battery in the event of a crash. In particular, this is intended to reduce the risk of a fire as a result of a short circuit. Pyrotechnic isolation elements, that is to say isolation elements which are driven by pyrotechnic fuels, are usually used for this purpose, the isolation elements destroying or disconnecting a current-carrying conductor as a result of the ignition of the fuel, and of the high pressure produced as a result, in the event of a collision, and therefore permanently isolating the current path, which is represented by this conductor, over an extremely short period of time.

A pyromechanical isolation apparatus which operates by pyrotechnics is known, for example, from European patent EP 1 447 640 B1, corresponding to U.S. Pat. No. 7,222,561. A propellant charge, which drives an isolating bit by an isolating piston, is electrically fired in the known apparatus by two connections which are connected, for example, to the control circuit of sensors for triggering airbags in the event of the motor vehicle being involved in a crash.

### SUMMARY OF THE INVENTION

It is accordingly an object of the invention to provide a tripping element for an on-board motor-vehicle electrical system which overcomes the above-mentioned disadvantages of the prior art devices of this general type, which is a simple and reliable tripping element for an on-board electrical system or an on-board electrical system current path of a motor vehicle, without the use of pyrotechnics.

With the foregoing nd other objects in view there is provided, in accordance with the invention, a tripping element for a current path in an on-board electrical system of a motor vehicle. The tripping element contains a voltage input, a load output for connecting a load, and a thermal circuit breaker connected within the current path between the voltage input and the load output. The thermal circuit breaker provides DC isolation for the current path as a result of an actuation signal.

To this end, the tripping element contains a thermal circuit breaker which is connected within the current path between a voltage input and a load output of the tripping element and provides—preferably permanent—DC isolation for the current path as a result of an actuation signal. The actuation signal is generated, for example, by a sensor for tripping the airbag in the motor vehicle (airbag signal).

The circuit breaker is, in particular, a rapid-action thermal circuit breaker, preferably using expanding wire technology. The circuit breaker is tripped by a defined short circuit. To this end, a power semiconductor (semiconductor switch) which is connected downstream of the circuit breaker and in parallel with the load output is provided, the actuation signal being routed to the control input of the power semiconductor.

In order to apply the actuation signal to the control input of the semiconductor switch, the tripping element has a control connection which is routed internally to the control input of the semiconductor switch and externally to a corresponding sensor (airbag or collision sensor). In this case, the signal which is used by a so-called crash sensor for tripping the airbag is preferably employed in this case.

In order to generate the short circuit, a thyristor in the form of a semiconductor switch is preferably switched to the on state, for example by an actuation electronics system. In the process, the actuation electronics system evaluates the airbag sensor signal or other or further sensor signals which monitor the various vehicle states.

The thermal circuit breaker is configured and formed to trip at a total current, which flows across the thermal circuit breaker—and therefore across the current path—of greater than or equal to 10 times the rated current over a tripping time of less than 20 ms, preferably less than 5 ms. In this case, the total current is made up of the load current which can be tapped off at the load output—and therefore possibly flows across the load—and the tripping current which flows across the semiconductor switch which is parallel to the load. In this case, the rated current is that current which may flow permanently.

The thermal circuit breaker is configured as an opener without an automatic resetting device. Therefore, after tripping, the circuit breaker has to be deliberately, for example manually, switched on again in order to reverse the isolation of the current path and therefore to reconnect the electrical circuit which is routed across the connected load.

The circuit breaker expediently has a fusible predetermined breaking point in order to reliably isolate the electrical circuit even in the event of failure of the thermal circuit breaker. In the case of a thermal circuit breaker which is configured in accordance with expanding wire technology, the expanding wire fuses in this case. This so-called fail-safe functioning ensures simple redundancy in the event of a fault in the thermal circuit breaker.

Other features which are considered as characteristic for the invention are set forth in the appended claims.

Although the invention is illustrated and described herein as embodied in a tripping element for an on-board motor-vehicle electrical system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a comparatively detailed circuit diagram of a functional principle of a tripping element according to the invention;

FIG. 2 is a block diagram of the tripping element with inputs and outputs according to FIG. 1 and with a connection to a crash sensor; and

FIG. 3 is a graph showing a current and signal/time graph of the various current and signal profiles in the event of tripping.

### DETAILED DESCRIPTION OF THE INVENTION

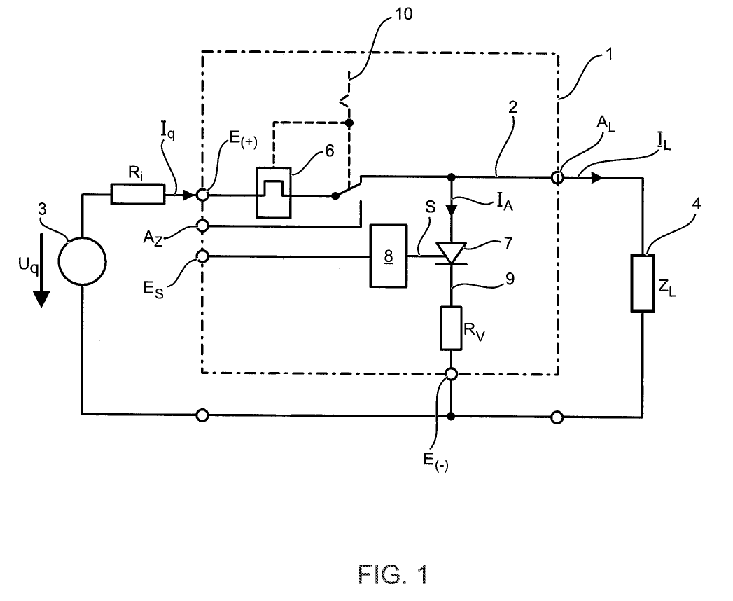

In the figures of the drawings, corresponding parts are provided with the same reference symbols in all the figures. Referring now to the figures of the drawing in detail and first, particularly, to FIG. 1 thereof, there is shown a tripping element 1 according to the invention in a current path 2 of an on-board electrical system of a motor vehicle. The tripping element 1 has a voltage input E₍₊₎ for connection to a positive pole of a voltage source 3 which supplies a source voltage 14. In the on-board electrical system of the motor vehicle, the voltage source 3 is usually the on-board electrical system or vehicle battery. The negative pole of the voltage source 3 is routed to a ground connection E₍₋₎ of the tripping element 1. The non-reactive resistor, which is illustrated between the voltage source 3 and the voltage input E₍₊₎ of the tripping element 1, represents the internal resistance Rᵢ of the voltage source 3.

The tripping element 1 also has a load connection (load output) A_{L} to which a load 4 with a load impedance Z_{L} is connected. The load 4 which is connected to the load connection A_{L} is likewise connected to the ground connection E₍₋₎ of the tripping element 1.

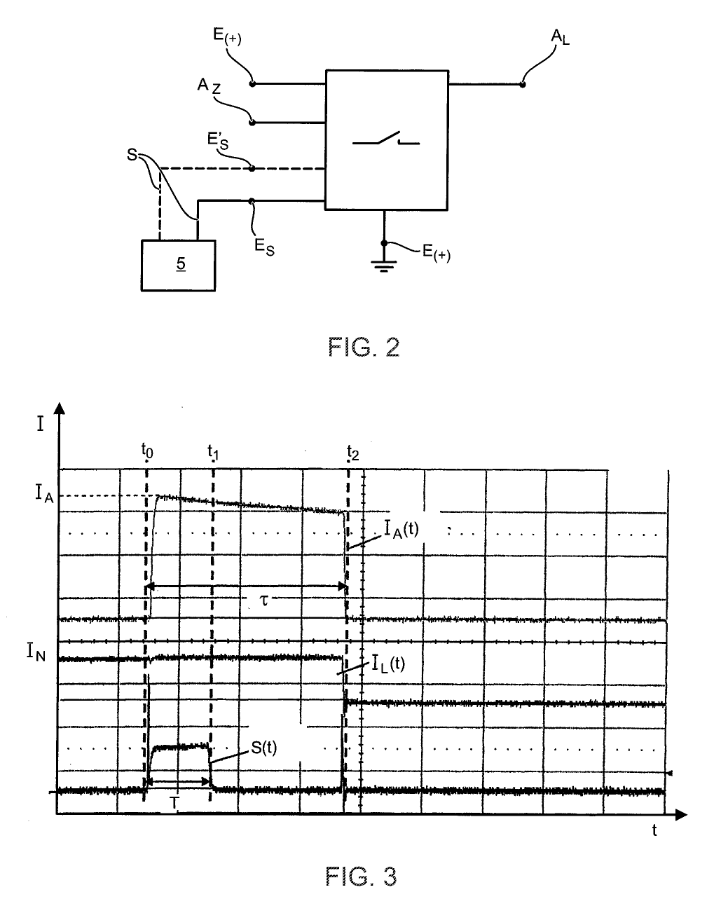

The tripping element 1 further includes a signal connection (signal input) E_{S}. Furthermore, the tripping element 1 contains a status signal connection A_{Z}. This input and output or connection configuration E_{(±)}, E_{S}, A_{L}, A_{Z} of the tripping element 1 is also illustrated in FIG. 2, with ground being indicated at the ground connection E₍₋₎.

FIG. 2 also shows the connection of a sensor, for example an airbag or crash sensor 5, to the signal input E_{S}. Since sensors of this type are often configured with two wires for safety reasons, a further signal input E′_{S} for a further signal wire of the sensor 5 is illustrated using dashed lines in FIG. 2.

The tripping element 1 is substantially constructed from a mechanical, in particular thermal, circuit breaker 6 and a semiconductor switch 7. The semiconductor switch 7 is connected between the load connection or load output A_{L} and the ground connection E₍₋₎ and thus forms a parallel circuit with a load 4 when the load is connected to the tripping element 1.

The semiconductor circuit 7 is preferably a thyristor, of which the anode is connected to the current path 2 between the thermal circuit breaker 6 and the load output A_{L}, and the cathode is routed to the ground connection E₍₋₎. When the semiconductor switch 7 is activated, the thermal circuit breaker 6 forms a series circuit with the semiconductor switch.

The gate of the semiconductor switch 7 is connected to an actuation electronics system 8 which, for its part, is connected by way of its input to the signal input or connection E_{S} of the actuation element 1.

The switching state of the thermal circuit breaker 6 can be checked at the status signal A_{Z} of the tripping element 1, that is to say can be tapped off at the status signal.

The tripping element 1 carries a load current I_{L} and is intended to isolate the load current in as short a time as possible when a specific event occurs, in particular in the event of a crash. In this case, the isolation is intended to be permanent and is intended to be able to be canceled only by deliberate resetting. The rapid-action thermal circuit breaker 6, which is preferably configured using so-called expanding wire technology, serves this purpose. In order to trip the thermal circuit breaker, a defined short circuit is generated, and for this reason the semiconductor switch or thyristor 7 is spontaneously switched to the on state by the actuation electronics system 8.

To this end, the actuation electronics system 7 evaluates a specific sensor signal of the sensor 5 or a number of sensor signals of various vehicle sensors and generates an actuation signal S for the semiconductor switch 7 which, as a result, is switched to the on state and is therefore activated. If the thermal circuit breaker 6 has been tripped as a result, the circuit breaker can be, for example manually, reset, and therefore the electrical circuit can be closed again by the previously interrupted current path 2, only by a deliberate action.

During normal operation, a current I_{q} flows from the voltage source 14, across the thermal circuit breaker 6 and through the load 4, to the ground connection E₍₋₎ and therefore to the negative pole of the voltage source 3. As long as the semiconductor switch 7 is switched off, the load current I_{L} is equal to the total current I_{q} and therefore equal to the so-called rated current I_{N}.

FIG. 3 shows the profiles I_{L}(t), I_{A}(t) and S(t) of the load current I_{L} and the tripping current I_{A} and the tripping signal S over time t. If the semiconductor switch 7 is switched on, a tripping current I_{A} flows toward the negative pole and therefore toward ground E₍₋₎, and therefore the load 4 is short-circuited. In order to limit the tripping current I_{A} in the tripping path 9 which is parallel to the load 4 and routed across the semiconductor switch 7, a limiting resistor R_{V} is connected in series with the semiconductor switch 7. The level of the tripping current I_{A} is set by the resistance value of the limiting resistor R_{V} in such a way that a multiple of the rated current I_{N} of the circuit breaker 6 flows. The following holds true

I_{q}(t)=I_{A}(t)+I_{L}(t)

with the impedance ratio R_{V}/|Z_{L}| between the limiting resistor R_{V} and the magnitude of the load impedance Z_{L} being selected in such a way that the load component I_{L}(t) of the total current I_{q}(t) which flows across the load 4 is negligibly low. This can be seen from the current profiles I_{A}(t) and I_{L}(t) in FIG. 3, with the scales for the tripping current I_{A} and the load current I_{L} (rated current I_{N}) on the ordinate being different.

On account of the high current pulse due to the short circuit across the semiconductor switch 7, which current pulse now flows across the thermal circuit breaker 6, the circuit breaker opens very quickly, preferably with a switch-off or tripping time of τ≦5 ms. As a result of the virtually spontaneous opening of the circuit breaker 6, this forces the total current I_{q} across the current path 2 to become zero (I_{q}=0). Consequently, the tripping current I_{A} flowing through the semiconductor switch 7 and therefore across the tripping path 9 is now also zero (I_{A}=0), and therefore the semiconductor switch 7 is switched off. The state of the circuit breaker 6 can be checked by the status signal connection A_{Z} and, for example, be signaled to a central on-board computer for further processing.

Since the thermal circuit breaker 6 is preferably configured as an expanding wire circuit breaker and accordingly is reversible or can be reset, the tripping element 1 can be used several times even after tripping, in contrast to the known pyrotechnic isolating apparatuses. To this end, the thermal circuit breaker 6 can be manually reset by a manual tripping device 10.

In addition, it is particularly advantageous to realize the tripping element 1 according to the invention in a comparatively cost-effective manner and for the tripping element to be highly reliable. The reason for this is that, in the event of failure of the circuit breaker 6, a weak point, preferably the expanding wire, fuses and therefore isolates the current path 2 and therefore the electrical circuit which is closed by the load 4. Furthermore, the tripping element 1 according to the invention provides for integrated protection against overcurrents and short circuits.

A further aspect of the tripping element 1 according to the invention is that the ground connection E₍₋₎ is configured in such a way that the components and, in particular, the cable withstand the surge in energy

$${E}_{A} = {\int }_{0}^{τ} {I}_{A}^{2} ( t ) d t$$

generated by the current pulse during tripping without damage. Here, τ=t₂−t₀ is the tripping time.

In the graph according to FIG. 3, t₀ is the trigger time at which the actuation signal S(t₀) activates or triggers the semiconductor switch (thyristor) 7. Time t₁ indicates the end time of the actuation or trigger signal S(t₁), and T indicates the duration of the actuation or trigger signal (T=t₁−t₀). The tripping current I_{A}(t) continues to flow across the tripping path 9 until the thermal circuit breaker interrupts the total current I_{q}(t) after the tripping time T of the thermal circuit breaker 6 has elapsed. The current value of the tripping current I_{A} is approximately equal to or less than ten times the rated current I_{N} of the circuit breaker 6, that is to say the rated current which may flow permanently across the circuit breaker 6.

1. A tripping element for a current path in an on-board electrical system of a motor vehicle, the tripping element comprising:
a voltage input;
a load output for connecting a load; and
a thermal circuit breaker connected within the current path between said voltage input and said load output and provides DC isolation for the current path as a result of an actuation signal.

2. The tripping element according to claim 1, further comprising a semiconductor switch having a control input and connected downstream of said thermal circuit breaker and is connected in parallel with said load output, the actuation signal being routed to said control input of said semiconductor switch.

3. The tripping element according to claim 2, wherein said semiconductor switch, which is activated as a result of the actuation signal, short-circuits said thermal circuit breaker.

4. The tripping element according to claim 2, wherein said semiconductor switch is activated for a time period which is required to trip said thermal circuit breaker.

5. The tripping element according to claim 1, further comprising an actuation electronics system for generating the actuation signal.

6. The tripping element according to claim 5, further comprising a signal connection, said actuation electronics system having an input connected to said signal connection.

7. The tripping element according to claim 5, wherein said actuation electronics system for generating the actuation signal evaluates a large number of sensor signals for monitoring vehicle states.

8. The tripping element according to claim 1, wherein said thermal circuit breaker trips in an event of a total current which flows across the current path which is greater than or equal to ten times a rated current over a tripping time of less than 20 ms.

9. The tripping element according to claim 1, wherein said thermal circuit breaker is configured as an opener without an automatic resetting means.

10. The tripping element according to claim 9, further comprising means for manually resetting a connected state with said thermal electrical circuit which is closed by means of the load.

11. The tripping element according to claim 1, wherein said thermal circuit breaker has a fusible predetermined breaking point for emergency, fail-safe isolation of the current path.

12. The tripping element according to claim 2, further comprising a limiting resistor for limiting a current and connected in series with said semiconductor switch.

13. The tripping element according to claim 1, wherein a status signal connection for checking a switching state of said thermal circuit breaker.

14. The tripping element according to claim 1, wherein said thermal circuit breaker trips in an event of a total current which flows across the current path which is greater than or equal to ten times a rated current over a tripping time of less than 5 ms.
